(19) United States
(12) Patent Application Publication
(10) Pub. No.: US 2021/0274973 A1
(43) Pub. Date: Sep. 9, 2021

(54) DEVICE FOR CONVEYING AT LEAST ONE POWDERED INGREDIENT, PREFERABLY COFFEE POWDER

(71) Applicant: CMA MACCHINE PER CAFFE' S.R.L., Susegana TV (IT)

(72) Inventors: Beppino CEOTTO, Susegana (TV) (IT); Andrea ZONELLI, Susegana (TV) (IT)

(73) Assignee: CMA MACCHINE PER CAFFE' S.R.L., Susegana TV (IT)

(21) Appl. No.: 17/255,483

(22) PCT Filed: Jun. 28, 2019
(86) PCT No.: PCT/IB2019/055497

§ 371 Date: Dec. 23, 2020

(30) Foreign Application Priority Data
Jun. 29, 2018 (IT) 102018000006831

(51) Int. Cl. A47J 42/40; A47J 31/60; A47J 31/42

(52) U.S. Cl. CPC A47J 42/40; A47J 31/42; A47J 31/60

(57) ABSTRACT

A device (1) for conveying at least one powdered ingredient, preferably coffee powder, from at least one grinding unit (2), or from a source container, to at least a storage container (3), is described. The device comprises at least one channel (10, 10′) having at least one input section (11, 11′) configured to receive at least one powdered ingredient from at least one grinding unit (2), or from a source container, and at least one output section (12, 12′) to deliver said powdered ingredient into at least one storage container (3). The device comprises at least one fluid source (50), preferably pressurized fluid, to deliver a fluid flow into said at least one channel (10, 10′).

### FIELD OF THE INVENTION

The present invention concerns the field of preparing beverages starting from at least one base powdered ingredient, such as for example coffee powder, which is preferably subjected to infusion by means of a liquid, such as for example hot water, preferably pressurized.

More in detail, the present invention concerns a device for conveying at least one powdered ingredient, from a source container, or from a grinding unit (grinder), to at least one storage, or destination, container, such as for example a filter-holder or an infusion chamber.

### KNOWN PRIOR ART

Such conveying devices are for example used in the grinders (or grinding assemblies) for example used in bars to grind coffee beans or grains, by means of one or more grindstones, and to convey the powder obtained by means of a channel in a storage (or destination) container, for example a filter-holder of a machine for preparing a beverage that is arranged by the barista downstream of the channel of the conveying device.

Moreover, the conveying devices are also used in machines for preparing beverages, such as for example machines for preparing coffee, preferably of the automatic type. In such machines, the coffee is in fact conveyed by means of a channel from a grinding unit, which as mentioned reduces the coffee beans to powder, or from a source container in which the ingredient, and in particular coffee, is already present in the form of powder, towards at least one storage container (arranged downstream of the conveying channel) which can be for example an infusion chamber, or a filter-holder, for example of the type removable from the machine.

In general, the conveying channel of the known devices is preferably tilted, substantially configured like a slide in which the powdered ingredient is conveyed, by gravity, from a source container, or a grinding unit, arranged upstream of the channel, up to a storage container arranged downstream of the channel, such as for example a filter-holder or an infusion chamber of the ingredient.

A drawback of the known conveying devices is that accumulations of the ingredient, which gradually reduce the passage section inside the conveying channel, may form over time due to the succession of conveying operations of the doses of powdered ingredient.

Also according to the characteristics of the powdered ingredient and the environmental conditions in which the device operates, and in particular the temperature and humidity conditions, it is possible that the powder can adhere to the inner surface of the conveying channel, and with the passing of time and the repeated conveying operations of successive doses of powdered ingredient determine an undesired and increasingly greater accumulation of the ingredient, which, as mentioned, progressively reduces the passage section.

For example, it was discovered that in given environmental conditions, for example in the event of high humidity, the phenomenon of an accumulation of coffee or another ingredient inside the conveying channel is more frequent.

The undesired reduction of the passage section of the channel determines the disadvantage of not being able to ensure the passage of the proper and desired amount of ingredient, thus compromising the proper and effective successive beverage preparation.

Such drawbacks are felt most strongly for example in machines for preparing beverages, and in particular coffee, wherein the heat generated by the infusion water, in addition to its vapor component present for example in the infusion chamber or in the filter-holder arranged downstream of the conveying channel, can at least partially come back up the conveying channel of the ingredient at the end and/or during the infusion and thus accentuate the undesired phenomenon of an accumulation of powdered coffee, and in general of the powdered ingredient conveyed.

In fact, the presence of humidity on the walls of the conveying channel determines the adhesion of the ingredient and the successive accumulation.

It is not always easy to access the conveying channel from the outside and thus the possible accumulation of the ingredient is not easy to remove without having to disassemble a part of the machine, or the grinder, to access the conveying channel.

Object of the present invention is to overcome the drawbacks reported in the known conveying devices.

More in detail, object of the present invention is to provide a conveying device, for example usable in a machine for preparing a beverage and in particular in a machine for preparing espresso coffee, or usable in a grinder or grinding unit, which allows to effectively, quickly and simply avoid the undesired accumulation of the powdered ingredient inside the conveying channel.

Further object of the present invention is to provide a conveying device which allows to be cleaned in a simple and quick manner without having to disassemble parts thereof, or to rely on the interventions of a technician.

### SUMMARY OF THE INVENTION

These and other objects are achieved by means of a conveying device according to the independent claim 1 and by means of a machine for preparing beverages, in particular coffee, and by means of a grinding device (for example of the standard type used in bars) comprising a conveying device according to the invention. Further aspects/characteristics are set forth in the dependent claims.

The invention further concerns a method of cleaning a conveying device.

The device for conveying at least one powdered ingredient, preferably coffee powder, according to the invention, comprises at least one channel having at least one input section configured to receive at least one powdered ingredient from at least one grinding unit, or from a source container (for example a container in which the ingredient already in the form of powder is preserved), and at least one output section to deliver the powdered ingredient into at least one storage container, such as for example a filter-holder of a machine for preparing beverages, and in particular coffee, or an infusion chamber of a machine for preparing beverages, and in particular coffee. It should immediately be noted that the term “channel” is here and hereinafter used to denote both a conveying element of the ingredient provided with an open section and a conveying element of the ingredient provided with a closed section, thus forming a duct.

The conveying device according to the invention is characterized by comprising at least one fluid source, preferably pressurized fluid, to deliver a fluid flow into the conveying channel of the powdered ingredient.

Advantageously, the presence of the fluid source allows to quickly, simply and effectively prevent the formation of accumulations of powdered ingredient inside the channel. In other words, the fluid source, and in particular the fluid flow delivered by it, which is at least partly delivered into the conveying channel, allows to effectively clean possible residues of powdered ingredient.

The conveying device thus provides an economic and effective solution to the reported drawbacks of the known devices briefly discussed above.

According to an aspect of the present invention, the fluid delivered is air, or a gas, or other gaseous body. Advantageously, the air or gas flow, preferably pressurized, effectively allows to eliminate the powder residues, which are thus conveyed towards the output section thereof in a simple and effective manner. In particular, with the present solution, there is no need to introduce contaminating elements or substances which could remain in contact with the inner walls of the conveying channel and thus be absorbed by the doses of powdered ingredients successively passing inside the channel. An advantage of such aspect is that the delivery of air, or a gas, or another gaseous body allows to avoid the use of water or other liquids which could dampen, and in general increase the humidity of the surfaces of the conveying device, which can have undesired effects on the powdered ingredient, preferably on the powdered coffee. For example, as mentioned, water or humidity can favor and increase the undesired phenomenon of adhesion of the powdered ingredient to the surface of the conveying channel and with the passing of time and the repeated conveying operations of successive doses of powdered ingredient, determine an undesired and increasingly greater accumulation of the ingredient, which progressively reduces the passage section. Moreover, an advantage of using air, or a gas, or another gaseous body, is the effective cleaning and removal of possible residues of powdered ingredients, without having to wait (before being able to convey a successive dose of powdered ingredient) for the conveying channel to dry. In fact, unlike liquids, the use of air, or a gas, or another gaseous body does not dampen the surfaces of the conveying device.

According to some aspects of the present invention, the fluid is delivered at least into a position selected from: upstream of the input section of the conveying channel, substantially at the input section of the conveying channel, in the first half of the extension in length of the conveying channel, or a combination thereof.

In other words, according to possible embodiments, the fluid flow (preferably air) is delivered so that it is at least partly directed into the conveying channel, preferably at or substantially at its upper part, so that to remove possible residues or accumulations of the powdered ingredient. Moreover, according to an aspect of the invention, the fluid flow is delivered, or is diverted by a surface of the conveying device, so that it has at least one component directed substantially towards the output section of the conveying channel.

According to an aspect of the present invention, the fluid source, preferably air, even more preferably pressurized air or compressed air, is of the type known in the art and comprises for example a pump or a compressor, preferably a compressor powered by direct current, or a fan and in general a device provided with one or more rotating blades (for example actuated by a motor) able to displace a fluid and preferably air by generating a fluid flow (stream). Possible embodiments in which the fluid source comprises a tank or container in which the fluid delivered in the conveying channel is housed are not however excluded.

The present invention also concerns a method of cleaning a conveying device of at least one powdered ingredient. The method is preferably carried out by means of the conveying device according to the invention. The method provides the step of operating at least one fluid source for delivering a fluid flow into at least one conveying channel of the ingredient.

According to an aspect, the step of operating the fluid source is carried out before, or during, or at the end of the passage of the powdered ingredient in the conveying channel, or by combining two or more of the preceding ways. Advantageously, the manual or automatic activation of the fluid source can be carried out before, after, or during the passage of a dose of an ingredient inside the conveying channel.

It should be noted that what is here described and/or claimed, with reference to the conveying device, can equally be applied to the method according to the invention, or vice-versa.

The present invention also concerns the use of at least one fluid source, preferably pressurized fluid, such as for example air, to clean at least one conveying device of at least one powdered ingredient, and in particular of coffee powder.

### BRIEF DESCRIPTION OF THE DRAWINGS

These and other advantages of the present invention will become clearer in the following description and accompanying drawings, provided by way of example and without limitations, in which:

FIGS. 1 and 2 are two perspective views, respectively front and back, of a possible embodiment of the conveying device according to the invention, in which the second movable channel is depicted in retracted position;

FIGS. 1A and 2A are two perspective views, respectively front and back, of a possible embodiment of the conveying device according to FIG. 1 and FIG. 2, in which the second channel is depicted in extended position;

FIG. 3 is a front detailed view of the output section of the conveying channel in which the second movable channel is shown in extended position;

FIGS. 3A and 3B respectively are a front view of the conveying channel in which the second movable channel is depicted in retracted position and a sectional view according to the plane B-B shown in FIG. 3A.

FIGS. 4 and 5 are two perspective views of a possible embodiment of the conveying device according to the invention, usable in a machine for preparing beverages, preferably coffee, of the automatic type, in which there is also at least one grinding unit and in which the second movable channel is shown in retracted position;

FIG. 4A is perspective view of a possible embodiment of the conveying device according to FIG. 4, usable in a machine for preparing beverages, preferably coffee, of the automatic type, in which there is also at least one grinding unit and in which the second movable channel is depicted in extended position.

### MODES FOR IMPLEMENTING THE INVENTION

With reference to the accompanying figures, a possible embodiment of the conveying device 1, according to the present invention, will now be described.

It should immediately be noted that, although reference will be made to powdered coffee hereinafter, the present invention is not to be understood as limited to such ingredient, but other powdered ingredients can obviously be used.

The device 1 for conveying powdered coffee (not shown in the accompanying figures) comprises at least one channel 10 having at least one input section 11 configured to receive the powdered coffee from at least one grinding unit 2, or from a source container, and at least one output section 12 to deliver the powdered coffee into at least one storage container 3.

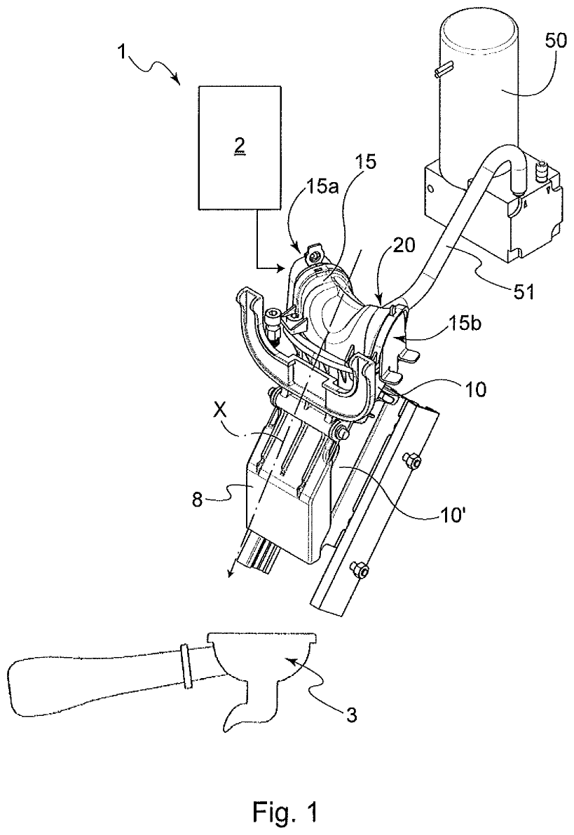

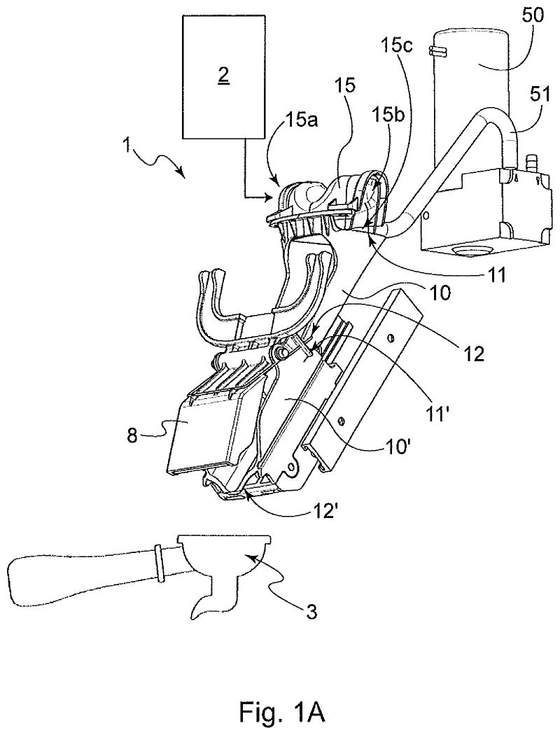

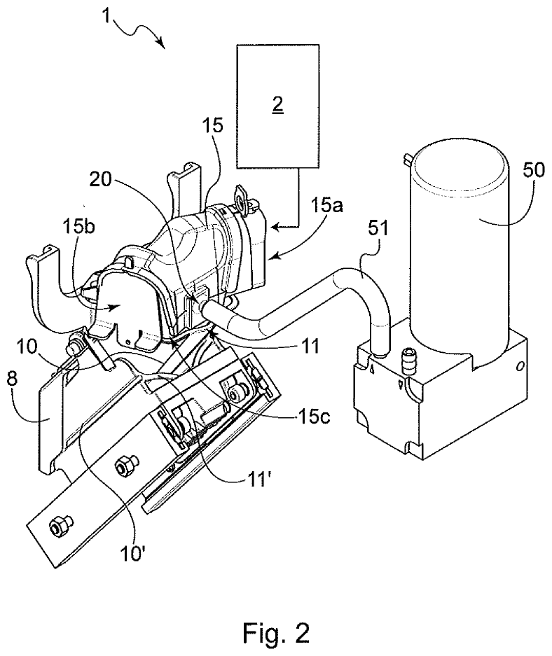

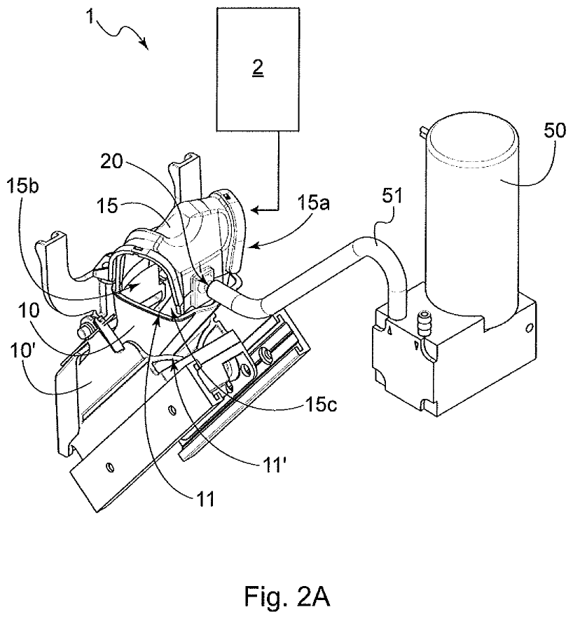

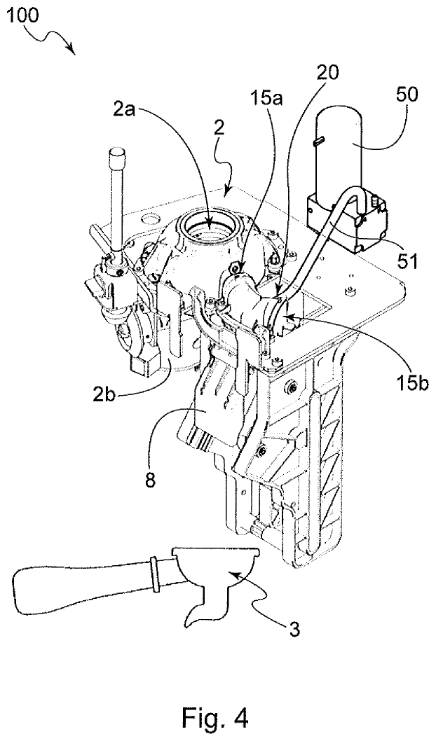

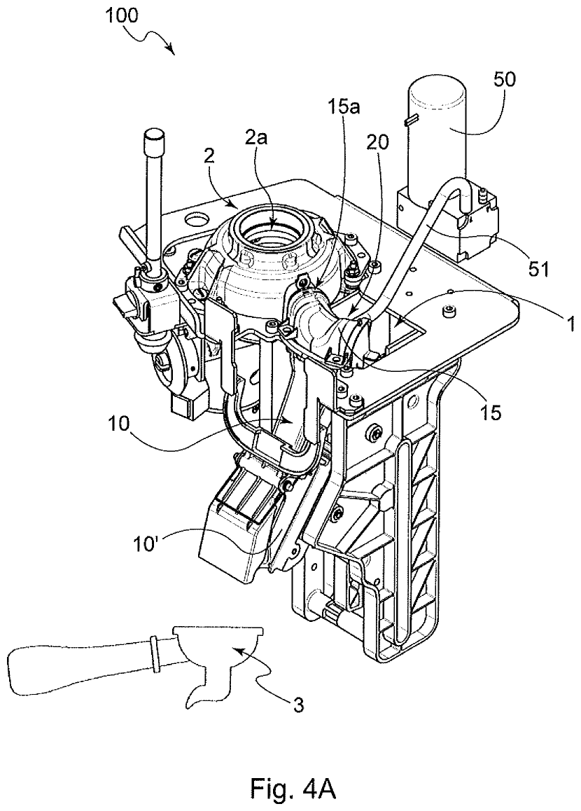

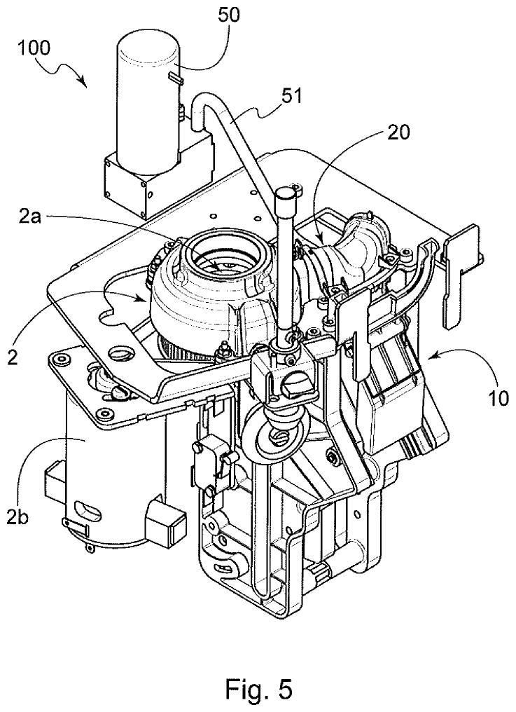

The presence of a source container 2, or a grinding unit, placed upstream of the conveying channel 10 is schematically shown in FIGS. 1, 1A, 2, 2A, 3, whereas a possible embodiment of the conveying device 1 usable in a machine 100 for preparing coffee of the automatic type, in which a grinding unit 2 connected to the channel 10 is also shown, is illustrated in FIGS. 4, 4A, 5. As known, such grinding unit comprises at least one grinding seat 2a, in which one or more grindstones or similar mincing elements such as one or more toothed wheels are placed to reduce the coffee grains or beans, inside a preservation container (not shown), to powder, and at least one driving motor 2b controlling and moving the grindstone and in general the mincing elements.

As far as the storage container 3 placed downstream of the conveying device 10 is concerned, it is also schematically shown in the accompanying figures and can comprise for example a filter-holder (such as for example schematically shown in the figures), for example of the removable type, or an infusion chamber for example formed by a cup-shaped seat intended to accommodate the coffee powder coming out of the conveying channel 10.

It should also be noted that the terms “downstream,” “upstream” are used to denote the position of a component of the device with respect to another, with reference to the flowing direction of the ingredient inside the device itself.

Embodiments in which the infusion chamber or filter-holder cooperate with a piston or movable cylinder, such as for example occurs in the machines for preparing coffee of the known art, in particular those of the automatic type, are not excluded. A machine of this type is described for example in the patent application WO2014/037495, in the name of the same Applicant as the one of the present patent application and it is to be here understood as being incorporated with reference to the characteristics of the machine for producing beverages in which the conveying device 1 according to the present invention can be used. In particular, the device according to the present invention can be used as a conveying means instead of the means described in the application WO2014/037495 with reference numbers 24, 25 and 48.

It should be noted that, although an embodiment in which the device 1 is provided with a second conveying channel 10′ placed downstream of the channel 10, in which the second channel 10′ is movable relatively to the channel 10 to form a conveying channel of the telescopic type, is shown in the accompanying figures, such embodiment is not limiting. In fact, the conveying device 1 according to the invention may not be provided with such at least one further channel 10′. As known and such as for example described in the patent application WO2014/037495, or in the patent application WO2016/151531, both in the name of the same Applicant as the one of the present patent application, the configuration of the conveying channel provided with a second channel 10′, movable with respect to the first, can be used to provide a retracted position (for example shown in FIGS. 1, 2, 4, 5) and an extended position (for example shown in FIGS. 1A, 2A, 3, 4A) of the conveying channel corresponding respectively to a position away from the storage container 3 (for example a filter-holder) that is placed downstream of the channel, and a position close to the storage container 3.

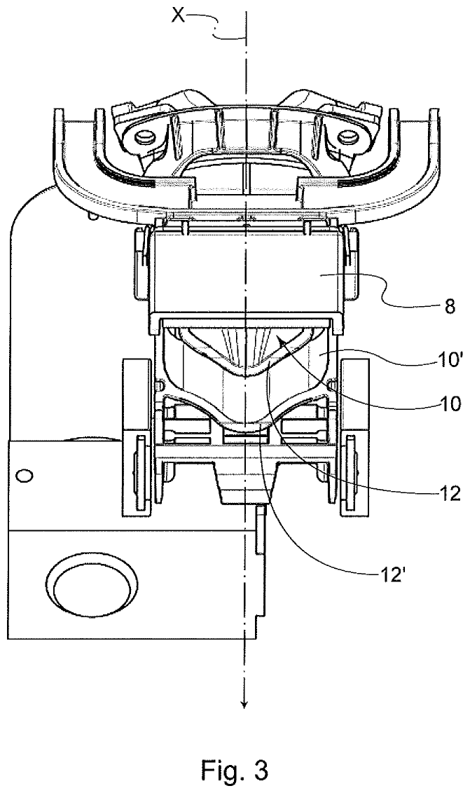

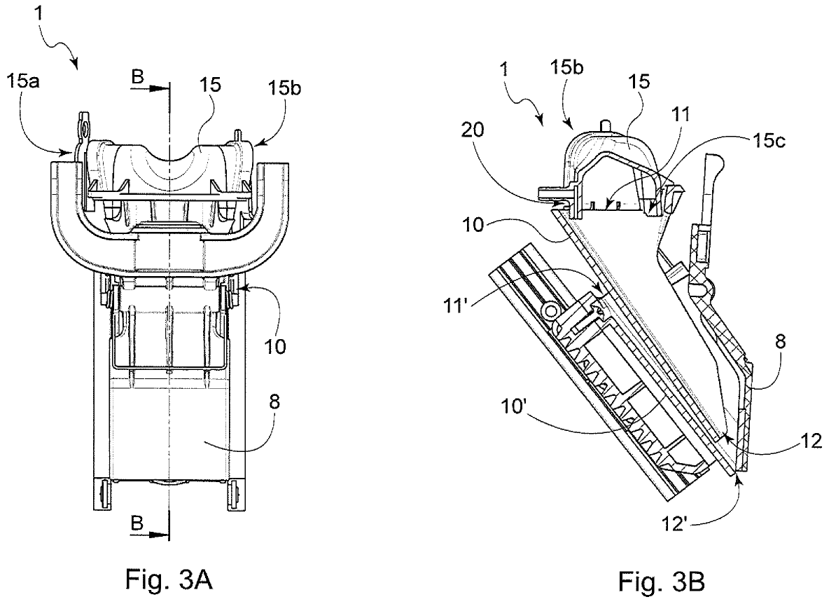

As is known, for example in the patent applications mentioned above, the retracted position of the second channel 10′ is useful in preventing the interference of the conveying channel with a piston or a movable cylinder cooperating with the filter-holder, and in general with the infusion chamber, to carry out the infusion of the coffee. The movement of the movable channel 10′ can occur according to known means, such as for example described in the application WO2016/151531, through a movement system by means of a toothed portion possibly synchronized with the movement of the movable piston, if present. Such movement means of the movable channel 10′, which for example comprise a motor adapted to move the toothed guide placed underneath the second channel 10′, see for example FIG. 3B, will not be described in detail here since known in the art and already described for example in the application WO2016/151531 whose text is here understood as being incorporated.

Returning to the conveying channel 10, 10′, it should be noted that the term “channel” is used in the present patent application both to denote an element with closed section, and an element adapted to convey provided with open section.

In other words, such as for example shown in the figures, the channel 10 can comprise an open section and, in particular, can be substantially U-shaped, i.e. can be provided with a lower surface and two side surfaces, for example according to a configuration similar to that of a slide. Despite this, although not shown in the accompanying figures, the conveying channel 10 can take a closed-section shape, i.e. a duct in the shape of the appropriately selected closed section, for example substantially rectangular or circular, etc.

According to an aspect, the conveying channel 10 transports the powdered ingredient by gravity, and is thus arranged tilted, or arranged vertically.

According to an aspect, the conveying channel has a substantially longitudinal extension and preferably substantially according to a rectilinear direction, or axis X.

Moreover, according to an aspect, the conveying channel, and in particular its lower surface, is not flat, but can be V-shaped or U-shaped if seen in cross-section. In general, the lower surface of the conveying channel can have a lowered central portion, forming a groove or a lowered fold, such as for example in the embodiment shown in the detailed front view of FIG. 3. Such shape allows to improve the distribution of the coffee powder delivered by the conveying channel into the storage container 3, so that to be uniform in its distribution, for example in the filter-holder 3.

That which is described and/or claimed with reference to the conveying channel 10 is also applied to the possible at least one second, or further, channel 10′ (possibly movable with respect to the first) which can also be provided with open section or with closed section. Moreover, the channel 10 and/or the at least one further channel 10′ can be provided with a door 8 or closing means, at its ends, and preferably at its output section. As for example shown in the accompanying figures, according to a possible embodiment, the door 8 extends at least partially in the upper portion of the channel and forms a part of the upper surface of the second channel 10′.

The opening and closing of the door 8 is obviously preferably automatic and preferably occurs when the movable channel 10′ is in the extended position.

As mentioned, according to the invention, the conveying device 1 comprises at least one fluid source 50, preferably pressurized, to deliver a fluid flow into the at least one conveying channel 10. The fluid source 50 can be configured to deliver the fluid into at least one further channel 10′, if present. The delivery of the fluid can occur in at least one channel selected from a first and a second channel, or in both. In other words, the delivery of the fluid can occur directly in the first channel 10 or directly in at least one further channel 10′, or the fluid flow delivered into a channel can be conveyed and can thus pass in at least one further channel 10′, if present, placed downstream of the channel 10 preceding it.

As mentioned, the presence of the fluid source 50 advantageously allows to quickly, simply and effectively prevent the formation of accumulations of powdered ingredient inside the channel. In other words, the fluid source, and in particular the fluid flow generated by it, which is at least partly delivered into the conveying channel 10, allows to effectively clean possible residues of powdered ingredient.

According to an aspect of the invention, the fluid source is fluidically connected to the at least one conveying channel 10, 10′ so that at least part of the fluid flow can be channeled into the conveying channel 10, 10′ of the ingredient.

The expressions “fluidic connection” or “fluidically connected” are here used to denote that a component of the device is connected to another component thereof to allow the transfer of fluid between them, i.e. allowing the fluidic communication.

According to an aspect of the invention, the fluid is preferably air or a gas and, in general, a gaseous body.

According to a possible embodiment, such as for example shown in the accompanying figures, the pressurized air source 50 comprises a compressor which can be connected to the conveying channel 10 by means of a duct 51 for example made of silicone, or other material.

In general, the fluid source 50 is connected to at least one opening 20, or to at least one nozzle, to deliver the fluid flow into the at least one conveying channel 10, 10′.

The at least one opening 20 to deliver the fluid flow can be arranged on a surface of the at least one conveying channel which is not in contact with the powdered ingredient, however, possible embodiments in which the at least one opening 20, or nozzle, to deliver the fluid is arranged on a surface of the channel on which the powdered ingredient passes, for example the lower bottom surface of the channel 10, are not excluded. In such case, the opening or nozzle is appropriately protected or shielded so that to prevent the entrance of the powdered ingredient inside the opening, or nozzle, but such as to simultaneously allow the passage of the fluid flow inside the channel 10. It should also be noted that the opening 20, or nozzle, to deliver the flow can take a shape such as to spread the flow.

Moreover, such as for example shown in the sectional view of FIG. 3B, according to a possible embodiment, the opening or nozzle to deliver the flow can comprise for example a first part (for example rectilinear) and a second part (for example perpendicular to the first part), having a different section from one another.

In general, it should be noted that the shape and/or section of the delivery opening, or nozzle, 20 can be appropriately selected. For example, the output section of the delivery opening or nozzle can be for example different and/or have different sizes with respect to the input section of the delivery opening or nozzle.

Obviously, embodiments in which there is more than one opening or more than one nozzle to deliver the fluid into the at least one channel 10 are not excluded. In such case, according to a possible embodiment, the plurality of delivery openings 20, or the plurality of nozzles, are arranged at a distance from each other along the conveying direction of the ingredient towards the storage container 3, i.e. are arranged at a distance from each other along the longitudinal extension direction X of the channel.

According to a possible embodiment, such as for example shown in the accompanying figures, the conveying channel 10 comprises at least one connecting portion 15 which can be made in one piece therewith, or which can be connected thereto. The connecting portion 15 comprises at least one inlet 15a connectable to at least one grinding unit 2, or to at least one source container, and at least an outlet 15c to convey the powdered ingredient to said input section 11 of the channel 10.

A grinding unit 2 connected to the inlet 15a of the connecting portion 15 is shown in the accompanying FIGS. 4, 4A, 5. The grinding unit is instead not shown for simplicity of illustration in FIGS. 1-3.

According to a possible embodiment, the connecting portion 15 comprises at least one second inlet 15b connectable to at least one second grinding unit, or to a second source container. Although only one grinding unit 2 is shown in the accompanying figures, it should be noted how the connecting portion 15 can be provided with a second inlet 15b which can be connected to a second grinding unit, or to a second source container.

It should be noted that, according to a possible embodiment, the at least one inlet 15a, 15b of the connecting portion 15 is arranged sideways with respect to the flowing direction of the ingredient inside the channel 10, and is in general arranged sideways with respect to the longitudinal extension direction X of the channel 10. Such configuration advantageously allows to be able to arrange one or more grinding units sideways with respect to the conveying channel 10 and to anyhow be able to transport the dose of the ingredient coming from one or both of the grinding units in the conveying channel 10.

Moreover, according to an aspect of the invention, the at least one inlet 15a, 15b of the connecting portion 15 lies in a plane which is incident and preferably substantially perpendicular to the plane where the input section 11 of the conveying channel 10 lies. According to an aspect of the present invention, the first and second inlets 15a, 15b of the connecting portion 15 for connecting to a first and to a second grinding unit 2, or to a first and to a second source container, are arranged in positions opposing to one another. In other words, the two inlets 15a, 15b, if present, are preferably arranged in side position, opposing one another, preferably symmetrically, with respect to the conveying direction of the powdered ingredient and preferably with respect to a longitudinal extension axis X of the conveying channel 10.

It should be noted that according to a possible embodiment, in which the connecting portion 15 of the conveying channel 10 is present, the fluid source 50 is connected to the connecting portion 15. Such as for example shown in the accompanying figures, the at least one delivery opening 20, or at least one nozzle, to deliver the fluid flow into the channel 10 is arranged on the connecting portion 15.

According to a possible embodiment, the at least one delivery opening 20, or at least one nozzle to deliver the fluid flow, connected to the source fluid 50 is arranged between the first and second inlets 15a, 15b of the connecting portion 15.

According to an aspect, the at least one delivery opening 20, or nozzle, is arranged in a substantially intermediate position with respect to the two inlets 15a, 15b, preferably at the median plane or anyhow in a position substantially equidistant from the two inlets 15a, 15b injecting the ingredient in the connecting portion 15 of the channel 10 and so that the fluid delivered by it can effectively eliminate powder residues and remove possible accumulations coming from both the grinding units 2 or the source containers possibly connected to the two inlets 15a, 15b.

The present invention further concerns a method of cleaning a conveying device 1 here described and/or claimed.

The method provides the step of operating the fluid source 50 to deliver a fluid flow into the conveying channel 10, 10′.

The step of operating the fluid source 50 can be carried out before, or during, or at the end of the passage of the powdered ingredient in the conveying channel, or by combining two or more of the preceding ways.

According to an aspect, the step of operating the fluid source 50 can be carried out before, or during, or at the end, of the activation of the grinding unit 2, and in particular of the motor 2b for preparing the powdered ingredient which is conveyed inside the channel 10, 10′, or by combining two or more of the preceding ways.

It should be noted that the step of delivering the fluid can be operated manually or automatically, for example by means of a control unit of the device 1, not shown in the accompanying figures.

The control unit can be connected, or can correspond to the control unit of the machine for preparing a beverage in which the conveying device 1 according to the invention can be used.

The manual operation can occur for example when the user, e.g. the barista, notices that there is an undesired accumulation of the ingredient inside the channel, for example because he notices that the amount coming out from the conveying channel does not correspond to the usual one, and notices a reduction thereof. In combination or in alternative to the manual control, the step of delivering the fluid can be automated, for example the fluid flow can be delivered for the cleaning of the conveying channel after each grinding cycle, or after a given number of preset grinding cycles.

According to an aspect, the cleaning and thus source 50 operating step to deliver the flow into the conveying channel last for more than 1 second, preferably for more than 3 seconds.

As mentioned, the conveying device 1 here described and/or claimed can be for example used in a grinding device of an ingredient, preferably coffee, such as for example those used in bars to provide coffee starting from beans or grains housed in a container connected to a grinding unit 2 and deliver them in a storage container 3, such as a removable filter-holder of a machine for preparing espresso coffee which is temporarily placed by the user (e.g. the barista) downstream of the output section 12 of the conveying channel 10.

In other words, the conveying device 1 according to the invention can be integrated and thus used in a standard grinding device or grinder (provided with a coffee bean or grain container connected to a grinding unit) and which is usable in combination with a coffee machine to provide the removable filter-holder of the machine with the powdered coffee when the filter-holder is displaced by the barista at the grinder or grinding unit.

Advantageously, as discussed above, the presence of the fluid source, and in particular air, advantageously allows to remove possible residues or accumulations of coffee powder from the conveying channel 10.

Moreover, the conveying device 1 here described and/or claimed can be for example used in a machine 100 for preparing beverages, preferably a machine for preparing coffee. In particular, the device can be used in a machine for preparing coffee of the automatic type. A machine of this type is for example described in the patent application WO2016/151531 and in the patent application WO2014/037495, both in the name of the same Applicant as the one of this patent application. The content of such documents intends to be incorporated here by reference.

According to an aspect, the automatic coffee machine 100, in which the conveying device 1 according to the present invention is used, comprises a coffee bean or grain container which supplies a grinder or grinding unit (for example shown in FIGS. 4, 4A, 5) which in turn supplies a filter-holder 3 with coffee powder by means of the conveying channel 10 of the device according to the invention.

As discussed above, it should be noted that the machine can comprise a first and a second coffee container for grains to be ground, not shown, which respectively supply a first and a second grinder 2 (of which only one is shown in the figures) to prepare the doses of ground coffee that is brought to the conveying channel 10 through its connecting portion 15.

Moreover, the coffee machine comprises at least an infusion unit which has an infusion piston (not shown in the accompanying figures) which is movable by means of appropriate movement means, for example an electric motor, and which cooperates with the filter-holder 3 for infusing the beverage.

1. Conveying device (1) to convey at least one powdered ingredient, preferably coffee powder, from at least one grinding unit (2), or from a source container to at least one storage container (3), the device comprising at least one channel (10, 10′) having at least one input section (11, 11′) configured to receive at least one powdered ingredient from at least one grinding unit (2), or from a source container, and at least one output section (12, 12′) to deliver said powdered ingredient in at least one storage container (3), characterized by comprising at least one fluid source (50), preferably of pressurized fluid, to deliver a fluid flow into said at least one channel (10, 10′).

2. Device (1) according to claim 1, wherein said fluid source (50) is connected to at least one opening (20), or at least one nozzle, to deliver the fluid flow into said at least one channel (10, 10′).

3. Device (1) according to claim 2, characterized in that said fluid source (50) is connected to a plurality of delivery openings (20), or a plurality of nozzles, to deliver the fluid flow into said at least one channel (10, 10′), preferably said plurality of delivery openings (20), or said plurality of nozzles, being positioned at a distance from each other along the conveying direction of the powdered ingredient towards the storage container (3).

4. Device (1) according to any one of the preceding claims, wherein the fluid from said source (50) is delivered at least into a position selected from: upstream of the input section (11, 11′) of the channel (10, 10′), substantially at the input section (11, 11′) of the channel (10, 10′), in the first half of the extension in length of the channel (10, 10′), or a combination thereof.

5. Device (1) according to any one of the preceding claims, wherein said channel (10) comprises at least one connecting portion (15) made in one piece with the channel or connected thereto, the connecting portion (15) comprising at least one inlet (15a) connectable to at least one grinding unit (2), or a source container, and at least an outlet (15c) to convey the powdered ingredient to said input section (11) of said channel (10).

6. Device (1) according to claim 5, characterized in that said connecting portion (15) comprises at least one second inlet (15b) connectable to at least one second grinding unit or a second source container, preferably said first and second inlets (15a, 15b) for connecting to a first and second grinding units, or a first and second source containers, being arranged in positions opposing to one another.

7. Device (1) according to claim 5 or 6, wherein said at least one opening (20), or at least one nozzle, to deliver the fluid flow into said at least one channel (10, 10′) is arranged on said connecting portion (15), preferably said at least one delivery opening (20), or at least one nozzle, to deliver the fluid flow being arranged between said first and second inlets (15a, 15b) of said connecting portion (15).

8. Device (1) according to any one of the preceding claims, characterized by comprising at least one second channel (10′) placed downstream of a first channel (10), preferably said second channel (10′) being movable with respect to said first channel (10).

9. Device (1) according to any one of the preceding claims, wherein said storage container (3) is selected between a filter-holder, preferably of removable type, and an infusion chamber.

10. Device (1) according to any one of the preceding claims, wherein said fluid is air, or a gas, or other gaseous body.

11. Device (1) according to any one of the preceding claims, wherein said fluid source (50) is selected among a pump, a compressor, a fan.

12. Device (1) according to any one of the preceding claims, wherein said at least one channel (10, 10′) comprises an open section, preferably said at least one channel (10, 10′) is substantially U-shaped.

13. Device (1) according to any one of the preceding claims, wherein said at least one channel (10, 10′) transports the powdered ingredient by gravity, preferably said at least one channel (10, 10′) is arranged tilted or vertically.

14. Machine (100) for preparing beverages comprising at least one conveying device (1) according to any one of claims 1 to 13.

15. Method of cleaning a conveying device (1) according to any one of the preceding claims, characterized by comprising the step of operating said at least one fluid source (50) to deliver a fluid flow into said at least one channel (10, 10′).

16. Method according to claim 15, wherein the step of operating the fluid source (50) is carried out before, or during, or at the end of the passage of the powdered ingredient in said channel (10, 10′), or by combining two or more of the preceding ways.

17. Use of at least one fluid source (50), preferably of pressurized fluid, for cleaning at least one conveying device (1) to convey at least one powdered ingredient, and in particular coffee powder.
